(19) United States
(12) Patent Application Publication
(10) Pub. No.: US 2021/0130624 A1
(43) Pub. Date: May 6, 2021

(54) MULTI-FUNCTIONAL HIGH PERFORMANCE HARDNESS COMPOSITION FOR CHEMICAL COATING PLATFORMS

(71) Applicant: PISON STREAM SOLUTIONS INC., New York, NY (US)

(72) Inventors: Joseph H. James, New York, NY (US); Sanjana Das, New York, NY (US); Subadhra Stoll, Brecksville, OH (US)

(21) Appl. No.: 16/668,899

(22) Filed: Oct. 30, 2019

(51) Int. Cl. C09D 5/03; C09D 167/00; C09D 7/40; C09D 7/62

(52) U.S. Cl. CPC C09D 5/037; C09D 5/031; C09D 7/62; C09D 7/70; C09D 167/00

(57) ABSTRACT

The invention consists of a multi-functional hardness composition that also serves as a mar/scratch resistant additive and flow modifier. The multifunctional hardness composition itself is a mixture of polyester resin, acrylic resin, curative, degassing agent, flow modifier and glass flakes. The multifunctional hardness composition may be introduced to finished coating compositions by way of a silica carrier.

### FIELD AND BACKGROUND OF INVENTION

The invention relates to additives for chemical coating compositions and, more specifically to a multifunctional hardness composition provided as a discrete, holistic powder composition that can be incorporated into powder and liquid coating formulations.

Powder coating compositions are dry, free-flowing powders. In use, these powders are applied to a substrate (e.g., electrostatic spraying, fluidized bed coating, and/or hot flocking), which is then heated. This added energy causes the powder to melt, flow, and fuse into a continuous film. Advantageously, this procedure results in a robust film with good adhesion, while effectively eliminating the need to rely upon solvents (and particularly volatile organic compounds).

Generally speaking, powder compositions are primarily composed of polyurethanes, polyester, polyethylene, and epoxy, as well as various combinations thereof (e.g., epoxy-polyester, urethane-polyester, etc.), as base resin(s). Polyisocyanates, triglycidylisocyanurate (TGIC) and TGIC-free curatives may be included, and other additives, such as flow control agents, hardeners, catalysts, fillers, pencil hardness agents, pigments, and charge inhibitors may also be incorporated to enhance the characteristics of the blend as it is mixed, applied, and/or fused. In operation, the resins melt and fuse together, while the additives facilitate various underlying attributes during or after fusion, all with the goal of creating a chemically non-reactive, durable, and continuous coating wherever the composition is applied to the substrate. In some instances, the formulation may be created to allow the composition to be used as a solid, dry powder or, by suspending or otherwise mixing that powder with a liquid carrier, in a liquid form.

Conventional formulations often rely on additives to impart a specific function to the coating composition, such as wetting, flow characteristics (e.g., viscosity, etc.), surface hardness, or other traits. In these prior art compositions, a separate coating additive was required to impart just one of these functions, with the additive usually becoming effective upon curing within the composition during application.

Because the base resins create the bulk of final chemical coatings (whether powder or liquid), it is generally thought to be desirable to maximize the amount of resin. In contrast, and especially to the extent that additives typically cost more and/or present unique formulation challenges in comparison to the base resins, additives tend to be used in their purest possible form but at the lowest possible levels while still delivering the desired attributes.

One area of particular concern is the inability of a coating to withstand mechanical actions such as rubbing, scraping or erosion. These mechanical actions can create irregularities that can weaken the coating film, making it more susceptible to marring and/or scratching, which lead to failure of the ASTM D3363-05 Standard Test Method for Film Hardness by pencil test, an accepted measure of mar/scratch and gouge hardness of a coating.

It is thought that increasing surface hardness and improving surface tension will improve/increase pencil hardness. One approach is to rely on multifunctional hardness compositions, such as homopolymers and copolymers of polyacrylates (e.g., esters of methacrylic and acrylic acids). Such additives can be provided in master batch dispersed on silica particles at an active level of up to 65 wt. % in the additive (or about 1.0 wt. % of the total composition), although additional additives may be required (e.g., Rucote 108 (Stepan), Additol VXW 6503N, Additol XW 6580 (Allnex) and Lanco 208 (Lubrizol)).

Other approaches include increasing extruder temperature and mix times, but the most prevalent means to address this defect is to increase or decrease the film build or thickness. Unfortunately, these “non-additive” solutions are not entirely satisfactory because they result in another undesired side effect known as “edge pulling.” Edge pulling is a condition in which the coating pulls away from the corners of the coated substrate resulting in incomplete formation of the finish.

The conventional additive solutions described above add cost owing to their reliance on various additional substances. Further, these additives may not be compatible with all coating platforms, and properly incorporating or introducing the additive into the formulation can present it own challenges. For example, the additive must provide an acceptable performance on the Hegman-type gage tests (e.g., ASTM D1210), which measures the fineness of dispersion of pigment vehicle systems, in order to be incorporated into liquid-based platforms.

Another issue with respect to existing additives, and particularly multifunctional hardness compositions, is that they generally serve only one purpose—to address the aforementioned issues with pencil hardness testing. Thus, the mass/volume dedicated within the overall composition to this single issue means lost opportunities to maximize the formulation in other respects.

Ultimately, the inability of the system to pass the pencil hardness test would result in rejection of the coated article, as it wouldn't adhere to ASTM D3363 Standard for coating hardness. In turn, such failed/rejected coatings require discarding of the coated articles and/or costly reworking thereof.

In view of the foregoing, a cost effective multifunctional hardness composition would be welcome. Further, a multifunctional hardness composition that served multiple purposes—including some of the other additive functions identified above-would be particularly helpful, especially to the extent such an additive could be used in either powder or liquid forms.

### SUMMARY OF INVENTION

The invention consists of a multi-functional hardness composition that also serves as a mar/scratch resistant additive and flow modifier. The multifunctional hardness composition itself is a mixture of polyester resin, acrylic resin, curative, degassing agent, flow modifier and glass flakes. This combination is extruded, ground and optionally introduced to conventional powder coating platforms at about 0.5 to 1.5 wt. % of the total combination. In some embodiments, the multifunctional hardness composition may be introduced to the conventional coating platform by way of (3-aminopropyl) trimethoxysilane (TMS) and/or other silica carriers (e.g., silicon dioxide at 45 to 55% active levels).

While the multifunctional hardness composition appears as if it could serve as a powder coating composition in its own right, the inventors have discovered that their formulation can be used as an additive in a wide range of different coating platforms without the need for other additives or compositions intended to improve hardness. Further, the multifunctional hardness composition itself is not formulated to be—and, in numerous embodiments, simply cannot serve as—a distinct, stand-alone coating composition.

One aspect contemplates a complete powder coating platform composition consisting of the aforementioned multifunctional hardness composition provided at between 0.5 and 1.5 wt. % and a finished powder coating, provided as the balance, having individual resins that are chemically distinct from the multi-functional hardness composition. Multiple resins and/or other optional additives, including hardeners, tetramethoxy glycoluril, pigments, waxes, catalysts, curatives and flow aids may be included in the additive as contemplated herein.

Further reference is made to the appended claims and description below, all of which disclose elements of the invention. While specific embodiments are identified, it will be understood that elements from one described aspect may be combined with those from a separately identified aspect. In the same manner, a person of ordinary skill will have the requisite understanding of common processes, components, and methods, and this description is intended to encompass and disclose such common aspects even if they are not expressly identified herein.

### DETAILED DESCRIPTION

Reference will now be made in detail to exemplary embodiments of the present invention. It is to be understood that other embodiments may be utilized, and structural and functional changes may be made without departing from the respective scope of the invention. Moreover, features of the various embodiments may be combined or altered without departing from the scope of the invention. As such, the following description is presented by way of illustration only and should not limit in any way the various alternatives and modifications that may be made to the illustrated embodiments and still be within the spirit and scope of the invention.

Any elements described herein as singular can be pluralized (i.e., anything described as “one” can be more than one). Any species element of a genus element can have the characteristics or elements of any other species element of that genus. The described configurations, elements or complete assemblies and methods and their elements for carrying out the invention, and variations of aspects of the invention can be combined and modified with each other in any combination. As used herein, the words “example” and “exemplary” mean an instance, or illustration. The words “example” or “exemplary” do not indicate a key or preferred aspect or embodiment. The word “or” is intended to be inclusive rather than exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

As noted above, the inventors endeavored to create a multi-functional hardness composition which could simultaneously address the issues of mar/scratch resistance and surface tension, while delivering added benefits to the powder and/or liquid coating compositions to which it might be added. These added benefits could include increased flow, improved surface tension, increased mar/scratch resistance, increased physical strength of the system, and increased and chemical resistance.

The multifunctional hardness composition disclosed herein is particularly advantageous because in addition to being effective as a multifunctional hardness composition it can be effective as a mar/scratch resistant additive and a flow modifier. It has now been discovered that a combination of polyester resin and acrylic resin blended in conjunction with additional constituents such as curatives, degassing agents, flow modifiers and glass flakes, —can be blended and extruded as masterbatch and having introduced (3-aminoproplyl) trimethoxysilane and silica type carriers such as silicone dioxide at (45-55% active) reduces orange peel significantly. The silica carrier is used in an amount of about 0.5 to 5.0% by weight based the balance of the multifunctional hardness composition being 100% as shown in the tables below.

In one embodiment, the multifunctional hardness composition is introduced to platform coating systems in an amount of about 0.5%-1.5%. In this implementation of the invention, conventional flow and leveling agents or additives—such as modified polyacrylates—are not necessary. For example, previous hardness additives such as polyacrylates (e.g., polymers or co-polymers of esters of methacrylic and acrylic acids) and flow aids and leveling agents (e.g., Resiflow P-67 (Estron Chemical), Resiflow P-1200 (Estron Chemical), Resiflow P-65, (Estron Chemical), Oxymelt A-2 (Estron Chemical), Modaflow 2000 (Allnex), and X-22 from (Monsanto) are not required.

Representative examples of polyester hydroxyl resins useful in one embodiment of the multifunctional hardness composition include: Crylcoat 2401-2 and Crylcoat 2471-4 from Allnex; SP-100 and SP-400 from Sun Polymers; and Rucote 102, 108 and Rucote 121 from Stepan Company.

Representative curatives useful in one embodiment include, Cretan NI2 blocked cycloaliphatic polyisocynate, Dow Chemical TGIC, (triglycidyllisocyanurate), Epikure 101 Imidazole Adduct, Epikure P-108 DICY Imidazole Adduct, aliphatic and cycloaliphatic amine multifunctional hardness composition from Momentive Industries and phenolic hardener DEH84 from Dow Chemical.

While not necessary to the underlying efficacy of the multifunctional hardness composition, it may also be possible to include anywhere from 0.3 to 0.8 wt. % (of the total multifunctional hardness composition) of one or more flow aids, such as PF45 sold by Pison Stream Solutions Inc. Additional or alternative aids of this nature are disclosed in U.S. Pat. No. 9,353,254, (which is incorporated by reference herein).

One of the advantages of the multifunctional hardness composition, at least in comparison to other coating additives and leveling agents, is that it may be inserted directly into a smooth texture coating platform binder system such as polyurethane, hybrid, TGIC, and Primid™ systems (manufacturers include EMS, Sun Polymer, Dow Industries, and Kukdo (Seoul, South Korea)). For epoxy system platforms, Kukdo Epoxy Resins KD-211E, KD-211G, KD-242G, KD-243C and Dow's D.E.R 633U and Vantico GT7013 epoxy resin can be added at about 0.5% up to about 4.0% by weight of total binder. In addition, this multifunctional hardness composition can also be post added/blended at about 0.03% up to about 0.9% by weight to act as an extender to current multifunctional hardness composition in formulation.

The multifunctional hardness composition can be added to liquid as well as powder coating formulations. The formulation may be combined with liquids such as water (preferably de-ionized and/or distilled), acetone, methyl-ethyl ketone (butanone), ethanol, and other, similar common industrial solvents, as well as combinations thereof. When the multifunctional hardness composition is combined with such a liquid carrier, the formulation volatilizes after the initial coating.

Typically, about 0.5% to about 1.5% by weight of a finished powder coating platform will be comprised of the multifunctional hardness composition. Unless otherwise stated, all percentages stated herein are weight percentages based on the total powder coating composition or, in the context of the multifunctional hardness composition component itself, the composition of the additive.

Coating platforms containing the hardness additive component are preferably added to a conventional thermosetting powder coating resin material. The material is selected from one or more of the groups of epoxy, epoxy-polyester, hydroxyl polyester, acrylic, TGIC polyester and TGIC-free polyester resins. Conventional additives, such as hardeners, tetramethoxy glycoluril, pigments, waxes, catalysts, flow aids, degassing agents and gloss modifiers may be included, although many of these additives will be unnecessary in view of the multifunctional hardness composition's capabilities.

Representative and suitable epoxy resins include Kukdo Epoxy resin KD-242H. KD-242H, is a bisphenol-A type solid epoxy resin which has excellent flow characteristics. KD-242H has an epoxy equivalent weight specification of 660-720 (g/eq), a softening point of about 85 to 95° C., and a melt viscosity of specification of about 2200 to 2800 cps at 150° C. Suitable hardeners include Kukdo KD-410J, Epikure 101 and Dyhard 100.

Dow Chemical's D.E.R 663U is a solid epoxy resin and is a standard medium molecular weight epoxy resin for powder coating applications. The resin has an epoxy equivalent weight specification of 730-820 (g/eg), a softening point specification of 92°−102° C. and a melt viscosity specification of 2000-4000 cps at 150° C. Suitable hardeners include Kukdo KD-401, KD-41, KD-410J, Epikure 101 and Dyhard 100.

Representative examples of epoxy-polyester resins useful in one embodiment include: Crylcoat 2401-2 and Crylcoat 2471-4 from Allnex; SP-100 and SP-400 from Sun Polymers; and Rucote 102, 106, and Rucote 118 from Stepan Company. The table below shows one example of a multifunctional hardness composition formulation in accordance with one embodiment of the invention (column 2) and approximated weight ranges covering other embodiments of the invention.

U.S. Pat. No. 9,353,254, which is incorporated by reference, describes a powder coating flow aid relying on a polyethylene resin combined with a polyester hydroxyl resin. A polymeric curative, degassing agent, ricinoleic acid (i.e., 12-hydroxy-9-cis-octadecenoic acid), and glass flake are also used, and the flow aid is introduced to powder coating compositions by way of a silica carrier. The polyethylene is provided at between 3.1 to 9.5 wt. %, the polyester hydroxyl at 35 to 50 wt. %, the polymeric curative at 5.0 to 10 wt. %, the degassing agent at 0.25 to 2.0 wt. %, the ricinoleic acid at 0.5 to 3.0 wt. %, glass flakes at 20 to 50 wt. %, and the silica carrier being 0.5 to 5.0 wt. % of the flow aid's total weight.

TABLE 1
Multifunctional hardness composition for use in finished coating compositions.

| Exemplary | Min/max | | |
|---|---|---|---|
| Weight (g) | range, wt. % | Component | Examples and notes |
| 500 | 45.0-55.0 | Polyester Resin 1 | TGIC Polyester with a viscosity of 20-45 Ps |
| | | | @ 200° C. and a T_{g} of 62° C.-68° C. |
| 300 | 25.0-35.0 | Acrylic Resin | Glycidyl methacrylate acrylic resin with a |
| | | | viscosity of 15-40 Ps @ 200° C., a equivalent |
| | | | weight of 300-350 and a T_{g} of 62° C.-68° C. |
| 45 | 2.0-7.0 | Curative(s) | TGIC (triglycidyllisocyanurate), Blocked |
| | | | cycloaliphatic polyisocyanate, Blocked |
| | | | aliphatic and aromatic polyisocyanate |
| | | | curatives |
| 10 | 0.5-2.0 | Degassing Agent(s) | Nonionic surfactant with a viscosity of 15- |
| | | | 20 mPas @ 55° C. with a freeze point of 53- |
| | | | 56° C. |
| 125 | 8.0-16.0 | Flow Modifier(s) | Contains polyethylene an polyester |
| | | | hydroxyl resins, along with curative, |
| | | | degasser, ricinoleic acid, and glass flake, on |
| | | | a silica carrier; see U.S. Pat. No. 9,353,254 |
| | | | (incorporated by reference) |
| 20 | 1.0-4.0 | Glass flake(s) | Corrosion resistant glass flake; particle size |
| | | | distribution between 150 μm-1700 μm (80 |
| | | | vol. % or more) |

Processing notes:
At ambient temperature and pressure, components above are admixed in a tumbler for 40-55 minutes or high speed mixer for 45-50 seconds until fully blended. Once blended, 1 gallon of liquid is added to the blended formulation. 30% of this liquid formulation is added to another fresh admixed and blended dry formulation. The blended material is then placed in the extruder hopper via the screw mechanism at 300 RPM to the extruder dye, preferably with three temperature zones at a feed rate of 400 g/min. The zone settings may be, respectively 60/60/100° C. The extrusion sheet product is then ground into particles (e.g., via a Retch mill grinder or coffee grinder) for 1-5 minutes at ambient temperature and pressure to form a powder having a most or substantially all of the particles preferably between about 30 to 50 μm in size.
* Stated weight ranges are calculated with respect to the final additive.

The formulations contemplated by Table 1 encompass any combination of values selected from each of the stated ranges. Any of these combinations can be extruded, ground to an optimized particle size (e.g., 100 nanometers to 5 micrometers), and adhered to a silica carrier such as (3-aminopropyl) trimethoxysilane and/or a silicone dioxide-precipitated amorphous silicate (45-55% active).

In one embodiment, the multifunctional hardness composition may be prepared by admixing the polyester resin, acrylic resin, curative, degassing agent, flow modifier and glass flakes. The components are admixed either in a tumbler for 40-55 minutes or with a MIXACO high speed mixer used for blending raw material constituents for 45-50 seconds at ambient temperature and pressure or until such components are fully blended. This admixture is then extruded to distribute the constituents and form an extrusion product. Any suitable extruder utilizing a single or twin screw mechanism may be used to form an extrusion product. The blended material is placed in the extruder hopper and fed via the screw mechanism to the extruder dye, preferably with three temperature zones. The zone settings may be, respectively, 60/60/100° C. The blended constituents are extruded at 300 RPM and at a feed rate of 400 g/min to form an extrusion product.

The extrusion sheet product is then ground into particles with a suitable grinding machine such as a Retch mill grinder or coffee grinder. The extrusion product is grounded for about 1-5 minutes at ambient temperature and pressure to form a powder having a typical particle size between about 30 to 50 μm. A Henschel high speed system is used to blend the powder for micronizing.

After grinding, this material can be used as desired to replace current multifunctional hardness compositions. For example, this material can be used as a replacement, as a single component for Rucote 108 from Stepan; Additol VXW 6503N and Additol XW 6580 from Allnex and Lanco 208 from Lubrizol. This product can also be post added at the percentages described above in the Summary section.

Notably, the extrudate that forms the multifunctional hardness composition is chemically distinct from the remaining components provided as part of the larger finished coating composition. That is, the distinct powder constiuents used to blend the coating composition are individually different from the powdered extrudate that constitutes the multifunctional hardness composition. Thus, particles of the hardness composition may include polyester along with acrylic, glass flakes, and other residuals constituents produced by extrusion of the hardness composition. A finished composition that is blended from separate and individually provided resins of polyester, acrylic, and/or other constituents (prior to extrusion of the coating composition) is, therefore, chemically distinct form the hardness composition.

In a first embodiment, a coating composition having any combination of the following elements is contemplated:
a multifunctional hardness composition component consisting essentially of: 45.0 to 55.0 wt. % polyester resin, 25.0-35.0 wt. % acrylic resin, 2.0 to 7.0 wt. % of curative, 0.5 to 2.0 wt. % of degassing agent, 1.0 to 4.0 wt. % glass flakes and 8.0 to 16.0 wt. % flow modifier.
at least one finished coating composition comprising one or more resins, wherein each of the one or more resins are chemically distinct from the extrudate and wherein the finished coating composition comprises at least 90% of the total weight of the chemical coating composition;
wherein the multifunctional hardness composition component is 0.06 to 1.50 wt. % of the total composition with the finished coating resin(s) and optional finished coating additives provided as remainder;
wherein the flow modifier is present at least 2.0 wt. % of the multifunctional hardness composition;
wherein the optional finished coating additives are present and include at least one additive selected from: 12-hydroxy-9-cis-octadecenoic acid, glass flakes, tetramethoxy glycoluril, pigments, waxes, hardening catalysts, and any combination of two or more thereof;
wherein the optional additives are present and wherein the finished coating resin(s) and the finished coating additives form a fusion powder coating film when the composition is cured;
wherein the optional additives are present and wherein the finished coating additives include a liquid carrier that is removed from a final, coating film when the composition is cured;
wherein the multifunctional hardness composition component is provided on a silica carrier;
wherein the silica carrier is selected from (3-aminopropyl) trimethoxysilane, silicon dioxide, and combinations thereof;
wherein the multifunctional hardness composition component is provided as particles each having a size of less than 5 micrometers;
wherein the finished coating resin(s) are provided as particles each having a size of greater than 20 micrometers;
wherein substantially all of the particles of multifunctional hardness composition component are greater than 100 nanometers and substantially all of the particles of finished coating resin(s) are less than 40 micrometers;
wherein a ratio of silica carrier to multifunctional hardness composition component is provided at between 1:1 and 1:2;
wherein the finished coating resin(s) includes thermosetting resins;
wherein the thermosetting resins are selected from the group consisting of epoxy resin, epoxy-polyester resin, acrylic resin, hydroxyl polyester resin, TGIC polyester, TGIC-free polyester resin, acrylic resin and any combination of two or more thereof;
wherein the thermosetting resin includes a polyester resin and acrylic resin;
wherein the polyester resin is a TGIC polyester and the acrylic resin is an acrylic copolymer.

In a separate embodiment, a multi-functional hardness composition for use in a coating composition having any combination of the following elements is contemplated:
45.0 to 55.0 wt. % polyester resin;
25.0-35.0 wt. % acrylic resin;
2.0 to 7.0 wt. % of curative;
0.5 to 2.0 wt. % of degassing agent;
1.0 to 4.0 wt. % glass flakes;
8.0 to 16.0 wt. % flow modifier;
wherein the multifunctional hardness composition component is provided on a silica carrier;
wherein a ratio of silica carrier to multifunctional hardness composition component is provided at between 1:1 and 1:2;
wherein the silica carrier is selected from (3-aminopropyl) trimethoxysilane, silicon dioxide, and combinations thereof;
wherein the multifunctional hardness composition component is provided as particles each having a size of less than 5 micrometers;
wherein the particles each have a size of greater than 100 nanometers; and

In a further embodiment, a coating composition includes any combination of the following:
at least one finished coating component provided at a weight ratio of 98 parts or more of the finished coating component and between 0.05 to 2 parts of either the additive or the coating composition described in the preceding paragraphs;
wherein the finished coating component includes a thermosetting resin and at least one additive selected from: 12-hydroxy-9-cis-octadecenoic acid, glass flakes, tetramethoxy glycoluril, pigments, waxes, hardening catalysts, and any combination of two or more thereof;
wherein the finished coating component forms a fusion powder coating film when the composition is cured; and
wherein the finished coating component includes a resin and a liquid carrier that is removed from a final, coating film when the composition is cured.

In yet another embodiment, a method for improving mar/scratch resistance and physical strength of material can include any combination of the following:
extruding an admixture comprising polyester resin, acrylic resin, curatives, degassing agents, flow modifiers and glass flakes;
mixing the admixture with a silica carrier at a weight ratio of additive to silica carrier between 1:1 and 1:2 to create a multifunctional hardness composition;
providing the additive component to a chemical coating base comprising at least one finishing resin to create a finished coating composition, wherein the additive component is provided at less than 1.5 wt. % of the finished coating composition;
applying and curing the finished coating composition on a substrate;
wherein between one to two times more multifunctional hardness composition is provided, by weight, than silica carrier when creating the additive component;
wherein all of the additive resin components are chemically distinct from the finishing resin(s); and
wherein the multifunctional hardness composition is subjected to grinding until a particle size of between 100 nanometers and 5 micrometers is achieved before the multifunctional hardness composition is provided to the silica carrier.

The multifunctional hardness composition as disclosed herein delivers the following advantages in comparison to finished chemical coating compositions:
Reduced surface tension which improves substrate wetting and leveling;
Improved surface tension in powder and liquid coating system platforms formed by coating compositions and constituents by aiding in creating a lower viscosity during the endothermic reaction period;
Improve mar and scratch resistance with standard powder coatings platforms such as TGIC, Hybrid (Polyester Epoxy combinations), and Epoxy from 2B up to 4H pencil hardness following Standard ASTM 3363 methods for Pencil Hardness test. Pencil hardness standard ranges are as follows: 6B, 5B, 4B, 3B, 2B, B, HB, F, H, 2H, 3H, 4H, 5H, 6H; and
Chemical resistance to a host of reagents such as acetic acid, sulfuric acid, hydrochloric acid and acetic anhydride corrosive acids and bases such as sodium hydroxide (NaOH) and potassium hydroxide (KOH)—all of which may be key reagents used for obtaining certification of conventional finished coating platforms.

Further, it should be noted that while the multifunctional hardness composition disclosed herein nominally includes components that are common to conventional powder coatings, the ancillary components (i.e., the non-resin components, such as curatives, degassing agents, flow modifiers, and the like) are not necessarily selected so as to make the multifunctional hardness composition a viable, stand-alone finished coating composition in its own right.

Instead, the multifunctional hardness composition is specifically formulated as a powder additive designed to integrate with conventional finished coating compositions so as to increase the ability to withstand mechanical actions and improve surface tension, as the finished coating compositions (including the inventive additive) are cured. This holistic approach to formulating an additive—by considering a combination of resins and ancillary components that deliver a synergistic effect—is, in the inventors' view, a stark departure from previous multifunctional hardness compositions and other additives. Whereas legacy commercial additives have identified one or two chemicals as “active” or important contributors to the multifunctional hardness composition's efficacy—with the additive itself then formulated to maximize the amount(s) of those active ingredients—the disclosed aspects of this invention acknowledge the significance of providing an entire binder system that itself melts and integrates with finished coating composition to which it is added and, eventually, cured.

Further, by relying on a silica carrier, the inventive multifunctional hardness composition can be integrated seamlessly during the curing process. That is, the micronized multifunctional hardness composition (i.e., particle sizes between 100 nanometers and 5 microns) can be introduced to the finished coating composition by way of an inert carrier that will simply become part of the final, cured coating. Further, by associating the multifunctional hardness composition with the silica carrier, storage and handling of the additive/agent is simplified.

One aspect of the disclosed formulations is that the amounts of each multifunctional hardness composition component are selected relative to ratio of additive to silica carrier. That is, the multifunctional hardness composition adheres to the silica carrier in known amounts, so that the combination additive-carrier is provided to the finished coating composition at the relatively low weight percentages contemplated herein. Further, given the aforementioned synergistic effects of the constituents of the additive, the relative (or “stoichiometric”) amounts of the constituents and silica carrier are important to the efficacy of the final additive.

The multifunctional hardness composition platform contemplated herein can be cured 10 min. @ 375° F. or 20 min. @350° F., using a convection oven such as laboratory oven (e.g., Blue M made in White Deer, Pa.). The additive is then milled or ground to a particle size that is appropriate for powder coating applications, with micronized sizes being most ideal when a silica carrier is used. In this manner, as little as 0.5 to 15 grams of multifunctional hardness composition per 1000 grams of finished coating powder can be effective when blending a finished powder coating composition, post extrusion (of the finished coating composition), according to certain aspects of the invention. Alternatively, as noted above, 0.5 to 1.5 wt. % of the multifunctional hardness composition can be blended and extruded with/as part of the finished coating composition.

In identifying appropriate resins for the multifunctional hardness composition (i.e., TGIC Polyester resin and Acrylic copolymer resin), alternatives can be identified so long as they have the same chemical composition and similar characteristics—such as the viscosity, T_{g} temperature, and/or differential scanning calorimetry—as the exemplary grades of material identified herein.

Further, coating compositions having the multi-functional hardness composition can be applied on various substrate types such as plastic, metal, aluminum, wood, concrete, paper, cloth, stucco and a host of other materials to act as a coating. Additional, exemplary resins and additives, suitable for such coating compositions, as disclosed in any of the references identified herein are also incorporated by reference. Still other components may be mixed into or formed as part of the extruded powder.

Unless specifically noted, all tests and measurements are conducted in ambient conditions according to commonly accepted measurement protocols (e.g., such as those regularly published by ASTM International) and relying upon commercially available instruments according to the manufacturer-recommended operating procedures and conditions. Specific tests and regimens identified in the military specifications noted above may be particularly informative, including ASTM E308, E1331, D3723, D476 (type III or IV), D3335, D3271, D2805, D1849, D3363, D7187, D3359, G154, G90, and B117. Unless noted to the contrary (explicitly or within the context of a given disclosure), all measurements are in grams and all percentages are based upon weight percentages.

Although the embodiments of this disclosure have been disclosed, it is to be understood that the present disclosure is not to be limited to just the described embodiments, but that the embodiments described herein are capable of numerous rearrangements, modifications and substitutions without departing from the scope of the claims hereafter. It is, of course, not possible to describe every conceivable combination of components or methodologies for purposes of describing the present specification, but one of ordinary skill in the art may recognize that many further combinations and permutations of the present specification are possible. Furthermore, to the extent that the term “includes” is used in either the detailed description or the claims, such term is intended to be inclusive in a manner similar to the term “comprising” as “comprising” is interpreted when employed as a transitional word in a claim. The claims as follows are intended to include all modifications and alterations insofar as they come within the scope of the claims or the equivalent thereof.

1. A chemical coating composition comprising:
a multifunctional hardness composition component consisting essentially of an extrudate of 45.0 to 55.0 wt. % polyester resin, 25.0-35.0 wt. % acrylic resin, 2.0 to 7.0 wt. % of curative, 0.5 to 2.0 wt. % of degassing agent, 1.0 to 4.0 wt. % glass flakes and 8.0 to 16.0 wt. % flow modifier.
a finished coating composition comprising one or more resins and optional additives, wherein each of the one or more resins are chemically distinct from the extrudate and wherein the finished coating composition comprises at least 90% of the total weight of the chemical coating composition.

2. The composition according to claim 1 wherein the multifunctional hardness composition component is 0.06 to 1.50 wt. % of the chemical coating composition, with the finished coating composition provided as a remainder.

3. The composition according to claim 1 wherein the flow modifier is at least 2.0 wt. % of the multifunctional hardness composition.

4. The composition according to claim 2 wherein the optional additives are present and include at least one additive selected from: 12-hydroxy-9-cis-octadecenoic acid, glass flakes, tetramethoxy glycoluril, pigments, waxes, hardening catalysts, and any combination of two or more thereof.

5. The composition according to claim 4 wherein the optional additives include a liquid carrier that is removed from a final, coating film when the composition is cured.

6. The composition according to claim 2 wherein the multifunctional hardness composition component is provided on a silica carrier.

7. The composition according to claim 6 wherein a ratio of silica carrier to multifunctional hardness composition component is provided at between 1:1 and 1:2.

8. The composition according to claim 6 wherein the silica carrier is selected from (3-aminopropyl) trimethoxysilane, silicon dioxide, and combinations thereof.

9. The composition according to claim 8 wherein the multifunctional hardness composition component is provided as particles each having a size of less than 5 micrometers.

10. The composition according to claim 9 wherein the finished coating resin(s) are provided as particles each having a size of greater than 20 micrometers.

11. The composition according to claim 10 wherein substantially all of the particles of multifunctional hardness composition component are greater than 100 nanometers and substantially all of the particles of finished coating resin(s) are less than 40 micrometers.

12. The composition according to claim 2 wherein the finished coating resin(s) include at least one thermosetting resin.

13. The composition according to claim 12 wherein the thermosetting resin or resins are selected from the group consisting of epoxy resin, epoxy-polyester resin, acrylic resin, hydroxyl polyester resin, TGIC polyester, TGIC-free polyester resin, acrylic resin and any combination of two or more thereof.

14. The composition according to claim 12 wherein the thermosetting resins consist essentially of: TGIC polyester resin and acrylic copolymer resin

15. A multi-functional hardness composition comprising:
45.0 to 55.0 wt. % polyester resin;
25.0-35.0 wt. % acrylic resin;
2.0 to 7.0 wt. % of curative;
0.5 to 2.0 wt. % of degassing agent;
1.0 to 4.0 wt. % glass flakes; and
8.0 to 16.0 wt. % flow modifier.

16. The multifunctional hardness composition according to claim 15 wherein the multifunctional hardness composition component includes a silica carrier.

17. The multifunctional hardness composition according to claim 16 wherein a ratio of silica carrier to multifunctional hardness composition component is provided at between 1:1 and 1:2.

18. The multifunctional hardness composition according to claim 17 wherein the silica carrier is selected from (3-aminopropyl) trimethoxysilane, silicon dioxide, and combinations thereof.

19. The multifunctional hardness composition according to claim 17 wherein the multifunctional hardness composition component is provided as particles each having a size of less than 5 micrometers.

20. The multifunctional hardness composition according to claim 19 wherein the particles each have a size of greater than 100 nanometers.

21. A chemical coating composition comprising at least one finished coating component provided at a weight ratio of 98 parts or more of the finished coating component and between 0.05 to 2 parts of the multifunctional hardness composition of claim 16.

22. The coating composition of claim 21 wherein the finished coating component includes a thermosetting resin and at least one additive selected from: 12-hydroxy-9-cis-octadecenoic acid, glass flakes, tetramethoxy glycoluril, pigments, waxes, hardening catalysts, and any combination of two or more thereof.

23. The coating composition of claim 22 wherein the finished coating component forms a fusion powder coating film when the composition is cured.

24. The coating composition according to claim 23 wherein the finished coating component includes a resin and a liquid carrier that is removed from a final, coating film when the composition is cured.

25. A process of making the coating composition according to claim 21 comprising:
mixing the multifunctional hardness composition component and the at least one finished coating resin(s) to form a mixture;
extruding the mixture to produce a coating extrudate; and
grinding the coating extrudate to a predetermined particle size range to produce the coating composition.

26. A process of making the coating composition according to claim 1 comprising:
mixing the multifunctional hardness composition component and the at least one finished coating resin(s) to form a mixture;
extruding the mixture to produce a coating extrudate; and
grinding the coating extrudate to a predetermined particle size range to produce the coating composition.

27. The process according to claim 26 further comprising, prior to the mixing, grinding the multifunctional hardness composition extrudate to an optimized particle size range.

28. The process according to claim 27 wherein the optimized particle size range is between 100 nanometers and 5 micrometers.

29. The process according to claim 27 wherein a weight ratio of silica carrier to multifunctional hardness composition extrudate is between 1:1 and 1:2.

30. The process according to claim 25 wherein the predetermined particle size range of the coating composition is between 20 and 40 micrometers.

31. A method of improving pencil hardness of a coating composition as it cures, the method comprising:
providing a multifunctional hardness composition to silica carrier to create an additive component;
providing the additive component to a chemical coating comprising at least one finishing resin to form a finished coating composition, wherein the additive component is provided at between 0.05 and 1.5 wt. % of the finished coating composition;
applying and curing the finished coating composition on a substrate; and
wherein between one to two times more multifunctional hardness composition is provided, by weight, than silica carrier when creating the additive component.

32. The method according to claim 31, wherein the additive component is chemically distinct from the finishing resin(s).

33. The method according to claim 32, wherein the multifunctional hardness composition is subjected to grinding until a particle size of between 100 nanometers and 5.00 micrometers is achieved before the multifunctional hardness composition is provided to the silica carrier.
